(19) United States
(12) Patent Application Publication
(10) Pub. No.: US 2023/0034484 A1
(43) Pub. Date: Feb. 2, 2023

(54) UNMANNED AERIAL SPRAYING SYSTEM

(71) Applicant: Hagay BAR, TEL AVIV (IL)

(72) Inventor: Hagay BAR, TEL AVIV (IL)

(21) Appl. No.: 17/788,037

(22) PCT Filed: Nov. 18, 2021
(86) PCT No.: PCT/IB2021/060688

§ 371 Date: Jun. 22, 2022

(30) Foreign Application Priority Data
Nov. 8, 2020 (IL) 278565

(51) Int. Cl. B64C 39/02; B64D 1/18; A62C 3/02

(52) U.S. Cl. CPC B64C 39/022; B64C 39/024; B64D 1/18; A62C 3/0242; B64C 2201/12; B64C 2201/145; B64C 2201/146; B64C 2201/162

(57) ABSTRACT

A tethered unmanned aerial spraying system comprising a tether line, a power source, a plurality of supporting beams and a plurality of pairs of motorized propellers, wherein each pair of motorized propellers is supported by the ends of a corresponding supporting beam, and a control unit configured to control each motorized propeller. The tether line includes a flexible hose for delivering spraying agent and a power line, supplying electricity to the motorized propellers from the power source. At least a portion of the tether line is covered by a rigid frame and is carried thereby, wherein the supporting beams are attached to the rigid frame so as to be arranged longitudinally to one another, and the neighboring supporting beams of pairs of motorized propellers have unequal length. The system provides compact configuration of an easily deployable system having increased stability and improved lifting capabilities or energy-effectiveness.

### FIELD OF THE INVENTION

The invention relates to unmanned aerial spraying systems. Specifically, the invention relates to a field of firefighting or agriculture.

### BACKGROUND OF THE INVENTION

Unmanned aerial spraying systems known from the art are generally used in the field of firefighting.

In the field of firefighting, ground firefighting crews are deployed in order to timely and effectively provide fire suppression. However, in some environments, for example forest fires, ground crew may have difficulty accessing certain terrain and be exposed to high-risk operating conditions. In order to overcome said drawbacks, aerial fire extinguishing systems were introduced.

For example, tethered aerial fire extinguishing systems are known from JP 2019083829 and WO 2014/080385. The known systems include a plurality of unmanned aerial vehicles (UAV) carrying a water hose. The water is carried from a water supply to a seat of fire using a water pump. This allows quickly supplying water to remote places without exposing firefighters to danger. Another configuration of a fire extinguishing system includes use of a lifting UAV carrying a hose and a firefighting UAV providing fire extinguishing, which is known from US 2017/0043872.

However, utilization of commonly used UAVs imposes constraints to the fire extinguishing system. In order to carry a heavy water hose suitable for firefighting it is necessary to use considerably bulky and heavy UAVs equipped with highly energy-consuming motors. That makes it difficult to transport the system and deploy it on site. Further, existing aerial fire extinguishing systems do not provide effective operation on large-scale fires having complex shape,

Use of aerial spraying systems is not limited only by fire extinguishing systems. For example, US20170043872 discloses use of UAVs to disperse agricultural chemicals over a field, Such implementation of UAVs has the same drawbacks as listed above.

Object of the invention lies in increasing lifting capabilities of an aerial spraying system, allowing equipment of a large diameter hose. Another object of the invention lies in increasing energy efficiency of a tethered unmanned aerial spraying system compared to solutions known from the art. Yet another object of the invention lies in increasing effective area covered by a tethered unmanned aerial spraying system and complexity of an area covered by a tethered unmanned aerial spraying system. Additional object of the pending invention lies in decreasing time and complexity of deploying a tethered unmanned aerial spraying system.

### SUMMARY OF THE INVENTION

To achieve desired objects and advantages of the invention, a tethered unmanned aerial spraying system comprising a plurality of UAVs is provided.

The tethered unmanned aerial spraying system comprises a tether line including a flexible hose for delivering spraying agent and a power line, supplying electricity to the plurality of pairs of motorized propellers, a plurality of supporting beams, each having a motorized propeller attached to the ends thereof, a power source, a pump, pumping the spraying agent from a spraying agent source, a control unit configured to control each motorized propeller, and a rigid frame covering at least one portion of the hose.

According to the invention, each pair of motorized propellers is supported by the ends of the corresponding supporting beam, while the neighboring supporting beams have unequal length. This allows providing a compact configuration of pairs of motorized propellers installing them close to each other.

Movement of each motorized propeller of the plurality of pairs of motorized propellers is controlled by the control unit, which adjusts thrust of each motorized propeller based on desired movement trajectory so that the tethered unmanned aerial spraying system is capable of performing any desired maneuver.

Additionally, each supporting beam of the system may be configured to pivot in relation to the rigid frame, to improve maneuverability and stability of the system in relation to forward/backward aerial movement. Preferably, each motorized propeller may be pivotable in relation to the corresponding supporting beam, so that the stability and maneuverability of the system during movement in every direction is maximized. Preferably, the supporting beams or at least parts of the supporting beams are pivotable.

The aerial spraying system can include any suitable navigational equipment, for example, a GPS module. Preferably, each end of each rigid frame is equipped with the GPS module. Motors, GPS modules, control units and control subunits are energized by a power source preferably provided on the ground or on a ground vehicle Preferably, up to 90% of the tether line has areas covered by the rigid frames. This way, pairs of motorized propellers can be distributed along the rigid frame on predetermined distance as close to each other as possible in order to provide as many motorized propellers on a rigid frame as possible without obstructing operation of each other. This allows providing at least one easily transportable and easily deployable aerial spraying module having improved lifting capabilities, allowing the system to use a large-diameter hose, therefore increasing spraying efficiency.

Moreover, this provides additional protection for the hose from thermal and mechanical damage. Additionally, this increases stability of the system when a plurality of outlets is provided in the hose by aligning the outlets along the length of the hose and providing counterbalance to the force produced by the water outlets that can destabilize movement of the system.

Alternatively, the system may use a hose having a standard diameter known from the art. In this case as motors of the plurality of closely disposed pairs of motorized propellers used in pending aerial spraying system can consume less energy to carry the tether line than the solutions known from the art, this allows providing an energy-efficient aerial spraying system.

The system may include a spraying agent outlet at the end of the hose, to provide the spraying agent to a desired location. Preferably, the system includes a plurality of spraying agent outlets in the portion of the hose is covered by a rigid frame to provide a wide area covered by the system. Preferably, several areas of the hose are covered by the rigid frame, forming several aerial spraying modules that can effectively cover areas having complex shapes.

Preferably, the material of the rigid frame is lightweight, strong, heat-resistant material, for example, aluminum, titanium, carbon fiber or any other suitable material.

The spraying agent source can be any accessible spraying agent source, for example, a tank provided on the ground or on a ground vehicle or any external source like a river, lake, fire hydrant, etc.

Sizes of the propellers and power of the motors are configured to be able to keep the system in the air during operation. At the same time, pairs of motorized propellers are disposed close to each other at least partially on the rigid frames, reducing possible dropping of the tether line, which may cause tangling of the tether line in trees, bushes or other obstacles, hindering the operation of the aerial spraying system. The plurality of GPS modules or any other navigational equipment provided on the system allows a control unit to understand where every aerial spraying module is located, determine its position in relation to the ground to control movement of the system in three dimensions. The control unit may be provided on the ground or a ground vehicle, and can communicate with each motorized propeller via wired connection or wirelessly. Preferably, all electrical equipment of the system is energized by a single power source provided on the ground or a ground vehicle. Supporting beams of the system can be foldable, to further facilitate transportation.

Provided tethered unmanned aerial spraying system is highly mobile and maneuverable. Introduced system is capable of forming a complex forms to access seats of fire that are difficult to reach and quickly extinguish fires having complex shape.

### BRIEF DESCRIPTION OF THE DRAWINGS

FIG. 1 illustrates a part of the tethered unmanned aerial spraying system according to pending invention. FIG. 2 illustrates the tethered unmanned aerial spraying system according to one embodiment of a folded mode.

FIG. 3 illustrates the tethered unmanned aerialspraying system according to another embodiment of a folded mode.

FIG. 4 illustrates a ground vehicle configured to utilize the tethered unmanned aerial spraying system.

FIG. 5 illustrates schematic view of the tethered unmanned aerial spraying system provided on a ground vehicle according to an embodiment of the invention, wherein the spraying agent is supplied from an external body of water.

FIG. 6 illustrates schematic view of the tethered unmanned aerial spraying system provided on a ground vehicle according to an embodiment of the invention, wherein the spraying agent is supplied from a fire hydrant.

### DESCRIPTION OF THE PREFERRED EMBODIMENTS

Preferred embodiments of the present invention will be presented and described below with reference to the accompanying drawings.

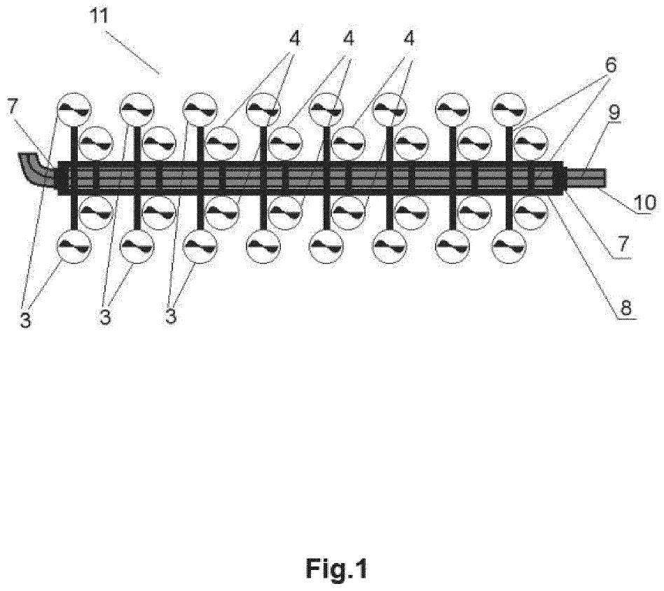

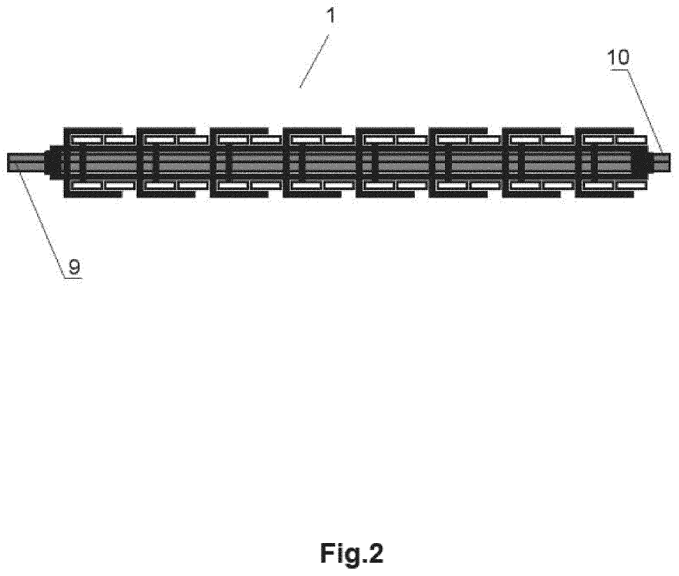

As shown in FIG. 1 , a tethered unmanned aerial spraying system (1) comprises a tether line, a power source (5), plurality of supporting beams (6) and a plurality of pairs of motorized propellers (3, 4), wherein each pair of motorized propellers (3, 4) is supported by the ends of a corresponding supporting beam (6), and a control unit configured to control each motorized propeller (3, 4). The tether line of the system includes a flexible hose (10) for delivering spraying agent and a power line (9), supplying electricity to the motorized propellers (3, 4) from the power source (5), the system further includes a pump (11) configured to pump a spraying agent from a spraying agent source to the flexible hose (10). The system is characterized in that at least a portion of the tether line covered by a rigid frame (8) and is carried thereby, wherein the supporting beams (6) of are attached to the rigid frame (8) so as to be arranged longitudinally to one another, and the neighboring supporting beams (6) of pairs of motorized propellers (3, 4) have unequal length. This way, pairs of motors can be installed closer to each other compared to conventional unmanned aerial spraying systems, providing a more compact configuration.

The tether line is carried by the motorized propellers (3, 4) using any suitable attachment, for example, hooks or fasteners provided on the rigid frame (8). Alternatively, the tether line may be protruded through the rigid frame (8) and fixed at the end of the rigid frame (8). Based on desired distance between the neighboring motorized propellers (3, 4) and sizes of the propellers, difference in length between the supporting beams (6) may be different. According to one preferred embodiment of the invention, the ratio of the lengths of the supporting beams (6) is 1:2. Number of pairs of motorized propellers (3, 4) may be different as well. According to one embodiment, supporting beams (6) are fixed to the rigid frame (8) of the system (1) and movement of the system (1) is controlled by control signals received by the control unit which adjusts thrust of each motor (3, 4) of the system to establish desired movement of the system (1).

According to another embodiment, the supporting beams (6) of the system are pivotable in relation to the rigid frame (8). This can be achieved, for example, by installing the supporting beams (6) on the rigid frame (8) using ring bearings or any other bearings that allow the beams (6) to be rotated. The supporting beams (6) are fixed on inner rings of the ring bearings, while outer rings are fixed to slots provided in the rigid frame (8) along with the rotary actuator that provides rotation of the beams (6) in response to the signal from the control unit. This configuration provides stable forward/backward movement of the system (1) without unnecessary tilting.

According to yet another embodiment, each motor (3, 4) is pivotally connected to the corresponding supporting beam (6) using, for example, universal joint, cardan joint, or any other means that provides tilting of the motor in relation to the supporting beam (6). According to this embodiment, each motor (3, 4) is configured to be tilted by a corresponding actuator in response to the signal from the control unit. This configuration further improves stability of the tethered unmanned aerial spraying system (1) movement.

According to another embodiment, supporting beams (6) are foldable. This allows the system to be easily and safely transported. According to one embodiment, the supporting beams (6) include two parts, bendable in relation to one another. In one particular embodiment, the supporting beam (6) includes two parts and an angle joint connecting them. The turning of the support beam parts is achieved by the actuator provided on the rigid frame (8), controlled by the control unit of the system (1). Preferably, the support beam parts can be turned in relation to one another up to the angle of 90°.

According to another embodiment, the motors of the motorized propellers (3, 4) of the system are installed on the supporting beams (6) through a bearing so that the motors can tilt in relation to the supporting beams (6). Tilting of the motors is achieved by the actuators provided on the rigid frame (8). Tilt angle of the motor is controlled by the control unit, controlling the corresponding actuator. Preferably, the motors rotatable in relation to the support beams (6).

According to another embodiment, the tethered unmanned aerial spraying system (1) comprises a GPS module (7). Preferably and according to the depicted embodiment, each end of each rigid frame (8) is equipped with the GPS module (7). This way, the control unit receives information on position of ends of each rigid frame (8) and can safely control movement of each rigid frame (8) in three dimensions. According to some embodiments of the invention, GPS modules (7) are detachably attached to the rigid frame (8) using clips, bolts, screws or any other suitable elements that provide secure fixation of the GPS modules (7).

According to embodiments of the invention, the rigid frame (8) and/or supporting beams (6) are made of aluminur, titanium, carbon fiber or any suitable combination of materials. Preferably, the power source (5) energizing the tethered unmanned aerial spraying system is provided on a ground or a ground vehicle (2).

According to one embodiment, the tethered unmanned aerial spraying system (1) comprises a spraying agent outlet at the end of the hose (10) in a form of a nozzle. Preferably, the tethered unmanned spraying system (1) comprises a plurality of spraying agent outlets provided along the length of the hose (10) in a form of sprinklers. The operation of the outlets is controlled by the control unit of the system (1). According to one embodiment, the control unit is a tablet computer or any other mobile computer terminal operated by a user from the ground.

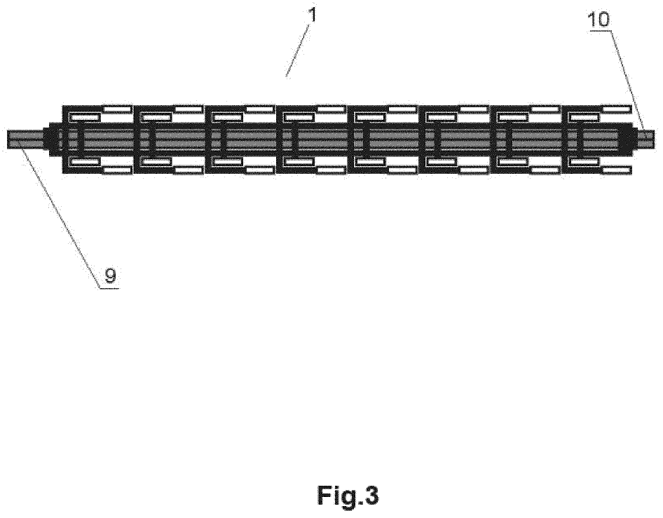

As it is seen from FIG. 2 and FIG. 3, the system (1) can be folded to facilitate transportation of the system. hi a folded mode, the supporting beams (6) are folded. According to the preferred embodiment of the invention, folded mode of the system includes folding the two-piece support beams (6) of the system and/or folding the motors of the system, as depicted on FIG. 2 or FIG. 3.

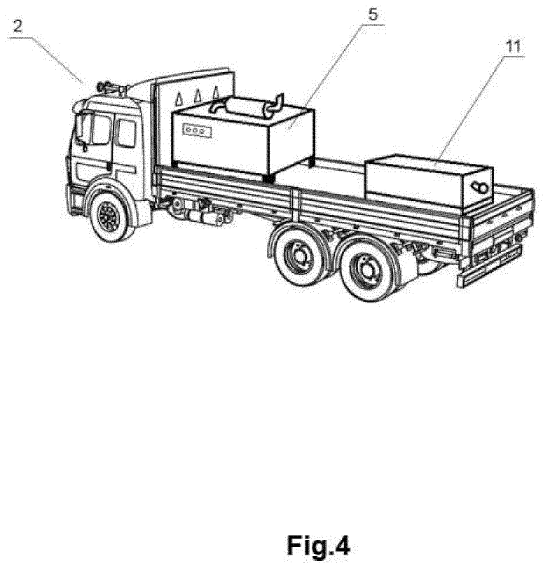

FIG. 4 illustrates a vehicle (2) carrying a generator as a power source (5) for the system and a pump (11) used to pump the spraying agent from any suitable external source according to one embodiment of the invention. According to another embodiment of the invention, the pump (11) can be combined with a fire suppressant source, such as a tank, provided on the ground vehicle.

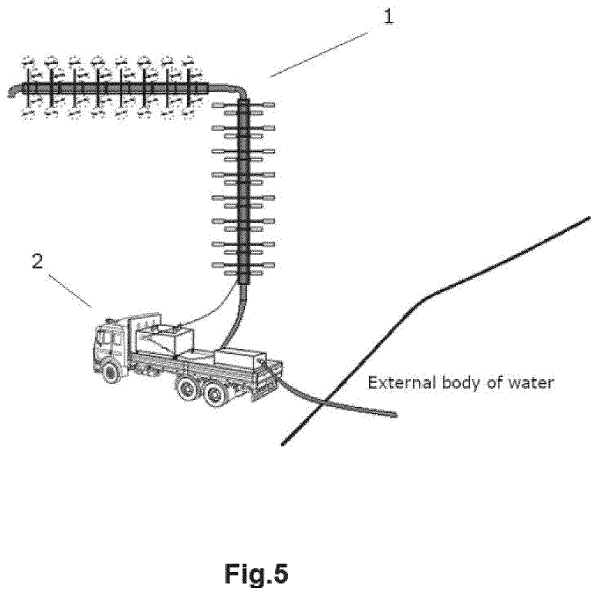

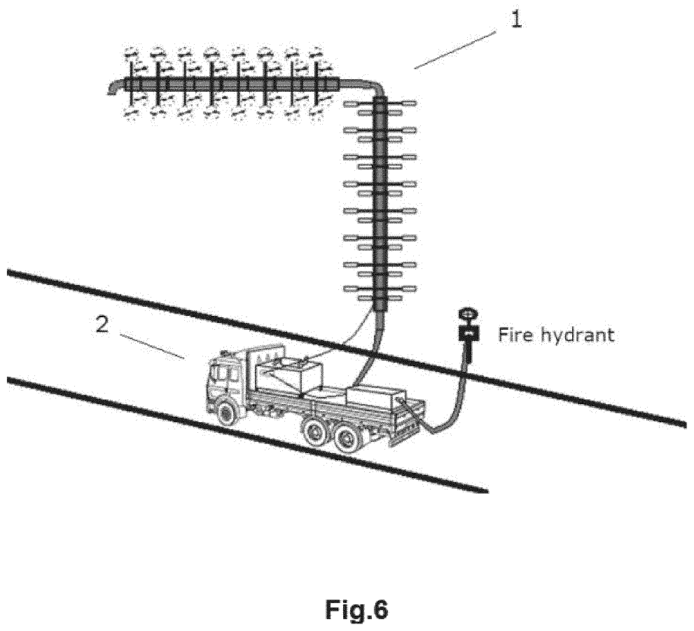

According to one embodiment illustrated on FIG. 5 or 6, the tethered unmanned aerial spraying system (1) has two portions of the tether line covered by rigid frames (8). The spraying agent according to the depicted embodiment is water drawn from external body of water, for example a river or a lake using a water pump provided on a ground or on a ground vehicle (2). According to one embodiment, portions of the tether line covered by the rigid frames (8) are 10 meters long, with 0.5 meters distance between each other. According to other embodiments, any number of portions can by covered by rigid frames (8). The spraying agent according to the embodiment depicted on FIG. 6 is water drawn from a fire hydrant.

According to another embodiment, the spraying agent is a chemical fire suppressing agent stored in a tank provided on a ground or on a ground vehicle (2). According to yet another embodiment, the chemical fire suppressing agent is a fire suppressing foam.

According to another implementation of the invention, the spraying agent is an agricultural chemical.

The tethered unmanned aerial spraying system (1) disclosed herein can be remotely operated by a user from ground or a ground vehicle (2) remotely. Further, the user can construct a route for the unmanned spraying system (1) and upload it to the control unit so that the system can operate automatically according to the inputted preset information.

The above is only the specific implementation mode of the disclosure and not intended to limit the scope of protection of the disclosure. Any variations or replacements apparent to those skilled in the art within the technical scope disclosed by the disclosure shall fall within the scope of protection of the disclosure. Therefore, the scope of protection of the disclosure shall be subject to the scope of protection of the claims.

### REFERENCE NUMERALS:

1—tethered unmanned aerial spraying system
2—ground vehicle
3, 4—motorized propellers
5—power source (generator
6—supporting beam
7—GPS module
8—rigid frame
9—power line
10—flexible hose
11—pump

1. A tethered unmanned aerial spraying system comprising:
a tether line;
a power source;
a plurality of supporting beams and a plurality of pairs of motorized propellers, wherein each pair of motorized propellers is supported by the ends of a corresponding supporting beam;
a control unit configured to control each motorized propeller;
the tether line includes a flexible hose for delivering spraying agent and a power line, supplying electricity to the motorized propellers from the power source;
a pump, configured to pump a spraying agent from a spraying agent source to the flexible hose, the system further characterized in that
at least a portion of the tether line is covered by a rigid frame and is carried thereby, wherein the supporting beams are attached to the rigid frame so as to be arranged longitudinally to one another, and
the neighboring supporting beams of pairs of motorized propellers have unequal length.

2. The system as recited in claim 1, wherein the ratio of lengths of the neighboring supporting beams is 1:2.

3. The system as recited in claim 1, wherein the supporting beams are pivotable.

4. The system as recited in claim 1, wherein the motorized propellers are pivotable in relation to the corresponding supporting beams.

5. The system as recited in claim 1, wherein the supporting beams or at least parts of the supporting beam are pivotable.

6. The system as recited in claim 1, wherein the system is equipped with a GPS module.

7. The system as recited in claim 6, wherein each end of each rigid frame is equipped with the GPS module.

8. The system as recited in claim 1, wherein the flexible hose comprises an outlet at the end of the hose.

9. The system as recited in claim 1, wherein the flexible hose comprises a plurality of outlets.

10. The system as recited in claim 1, wherein the spraying agent source is an external spraying agent source, provided on the ground or on a ground vehicle.

11 The system as recited in a claim 1, wherein the power source is provided on the ground or on a ground vehicle.

12. The system as recited in claim 1, wherein the system is remotely operated by a user by sending control signals to the control unit.

13. The system as recited in claim 1 wherein the control unit is configured to operate the system according to preset information.
